(19) United States
(12) Patent Application Publication
(10) Pub. No.: US 2002/0087862 A1
(43) Pub. Date: Jul. 4, 2002

(54) Trusted intermediary

(76) Inventors: Sandeep Jain, Belmont, CA (US); Sudheer Thakur, Belmont, CA (US); Kevin Darryl Jeu, Santa Clara, CA (US)

Correspondence Address: HICKMAN PALERMO TRUONG & BECKER LLP, 1600 Willow Street, San Jose, CA, 95125-5106, US

(21) Appl. No.: 09/754,907

(22) Filed: Jan. 4, 2001

Related U.S. Application Data
(60) Provisional application No. 60/175,136, filed on Jan. 7, 2000.

(51) Int. Cl. H04L 9/00

(52) U.S. Cl. 713/176; 380/277

(57) ABSTRACT

Mechanism are provided for a trusted intermediary partner to mange the encryption/decryption keys of trading partners in a trading community. As the trusted intermediary manages the public signature decryption keys for each potential sender, the recipient does not have to manage these keys. In one embodiment, a recipient receives a message from a sender via the trusted intermediary, knowing that the message originates from an authentic sender, but not from an imposter. The sender sends the message together with a digital signature of the sender, which is created from the private signature creation key of the sender, to the trusted intermediary. The trusted intermediary, having the public signature decryption key associated with the private signature creation key of the sender, uses this public signature decryption key to authenticate the sender, i.e., verifying that the message originates from a real sender, and not an imposter. Upon verifying that the message indeed originates from the authentic sender, the trusted intermediary sends the message together with a digital signature of the trusted intermediary, which is created from the private signature creation key of the trusted intermediary, to the recipient. The recipient, receiving the message and the digital signature and having the public signature decryption key associated with the private signature creation key of the trusted intermediary, uses this public signature decryption key to authenticate the trusted intermediary, i.e., verifying that the message comes from an authentic trusted intermediary, and not an imposter. If the message indeed comes from the authentic trusted intermediary, then the recipient knows that the message originates from the authentic sender, who has been authenticated by the trusted intermediary. In one embodiment, the trading partners may use message encryption/decryption keys to encrypt/decrypt the message. In this embodiment, the trusted intermediary maintains public message encryption keys of all potential recipients, eliminating the need for each sender to manage these public message encryption keys.

### FIELD OF THE INVENTION

The present invention relates generally to encryption/decryption keys used in sender-recipient message communications, and, more specifically, to using a trusted intermediary to manage such keys.

### BACKGROUND OF THE INVENTION

Society's reliance on computer systems is ever-increasing. With the increase in reliance comes an increase in the need for security. Specifically, it is critical for a company that engages in electronic commerce to know that the party with whom communications are being exchanged is the party that the company believes it to be. For example, a company that allows an accounting firm to electronically retrieve and process its salary, sales and inventory information would want to be very sure that the company to whom it is sending the information is, in fact, the designated accounting firm. Such assurance is critical when the transmission of confidential information takes place over a network to which many other parties have access (such as the Internet).

### Secure Communication

Cryptography is the art and science of keeping messages secure. A message is information or data that is arranged or formatted in a particular way. In general, a message, sometimes referred to as “plaintext” or “cleartext,” is encrypted or transformed using a cipher to create “ciphertext,” which disguises the message in such a way as to hide its substance. In the context of cryptography, a cipher is a mathematical function that can be computed by a data processor. Once received by the intended recipient, the ciphertext is decrypted to convert the ciphertext back into plaintext. Ideally, ciphertext sufficiently disguises a message in such a way that even if the ciphertext is obtained by an unintended recipient, the substance of the message cannot be discerned from the ciphertext.

Many different encryption/decryption approaches for protecting information exist. In general, the selection of an encryption/decryption scheme depends upon the considerations such as the types of communications to be made more secure, the particular parameters of the network environment in which the security is to be implemented, and desired level of security. An important consideration is the particular system on which a security scheme is to be implemented, since the level of security often has a direct effect on system resources.

For example, for small applications that require a relatively low level of security, a traditional restricted algorithm approach may be appropriate. With a restricted algorithm approach, a group of participants agree to use a specific, predetermined algorithm to encrypt and decrypt messages exchanged among the participants. Because the algorithm is maintained in secret, a relatively simple algorithm may be used. However, in the event that the secrecy of the algorithm is compromised, the algorithm must be changed to preserve secure communication among the participants. Scalability, under this approach, is an issue. As the number of participants increases, keeping the algorithm secret and updating it when compromises occur place an undue strain on network resources. In addition, standard algorithms cannot be used since each group of participants must have a unique algorithm.

To address the shortcomings of traditional restricted algorithm approaches, many contemporary cryptography approaches use a key-based algorithm. Generally two types of key-based algorithms exist: (1) symmetric algorithms and (2) asymmetric algorithms, of which one example is a public key algorithm. As a practical matter, a key forms one of the inputs to a mathematical function that is used by a processor or computer to generate a ciphertext.

Public key algorithms are designed so that the key used for encryption is different than the key used for decryption. These algorithms are premised on the fact that the decryption key cannot be determined from the encryption key, at least not in any reasonable amount of time with practical computing resources. Typically, the encryption key (public key) is made public so that anyone, including an eavesdropper, can use the public key to encrypt a message. However, only a specific participant in possession of the decryption key (private key) can decrypt the message. Thus, the owner of a public key requests all parties that wish to send the owner an encrypted message, to encrypt the message using the public key of the owner. All messages thus encrypted can only be decrypted by the owner, using the owner's corresponding private key.

The public key technique is generally used to establish a secure data communication channel through key exchanges among the participants. Two or more parties, who wish to communicate over a secure channel, exchange or make available to each other public (or non-secure) key values. Each party uses the other party's public key value to privately and securely compute a private key, using an agreed-upon algorithm. The parties then use their derived private keys in a separate encryption algorithm to encrypt messages passed over the data communication channel. Conventionally, these private keys are valid only on a per communication session basis, and thus, are referred to as session keys. These session keys can be used to encrypt/decrypt a specified number of messages for a specified period of time.

A typical scenario involves participants party A and party B, in which party A is considered a publisher of a message to a subscriber, party B. The public key algorithm used to establish a secure channel between publisher, party A, and subscriber, party B, is as follows:

Party B provides a public key, B, to party A.

Party A generates a random session key SK, encrypts it using public key B and sends it to party B.

Party B decrypts the message using private key, b (to recover the session key SK).

Both party A and party B use the session key SK to encrypt and decrypt their communications with each other. After the communication session, party A and party B discard SK.

The above approach provides the added security of destroying the session key at the end of a session, thereby, providing greater protection against eavesdroppers.

### Authenticating Public Keys

In the scenario described above, it is assumed that the entity that sent the public key to party A was really party B. If party B is not the party that sent the public key to party A, then security has been compromised because party A has merely prevented some eavesdroppers for obtaining sensitive information by establishing a secure connection with a party which is itself an eavesdropper.

One technique used to verify the true public key of a party employs a trusted third party authentication mechanism, such as a certificate authority (“CA”) to regulate the exchange of keys. In a certificate authority scheme, a party that desires to participate in a secure communication may apply for a digital certificate from a CA. Upon verifying the identity of the requester, the CA sends to the requestor a digital certificate. Typically, a digital certificate is contains: (a) cleartext identification information about the entity the certificate represents (name, location, organization, etc.), (b) the public key associated with the entity represented, and (c) a signature of a certifying authority (i.e. a CA, or certificate authority). The signature of the CA is typically encrypted using the CA's private key, and may be decrypted using the CA's public key.

Thus, instead of sending its public key to party A, party B sends to party A the digital certificate that it received from CA. Party A decrypts the signature within the digital certificate using the public decryption key of CA. If the digital certificate is authentic (i.e. was really issued by CA), then the public decryption key of CA will successfully decrypt the digital signature. If the certificate is authentic and the identity information in the certificate identifies party B, then party A can be assured that messages that it encrypts using the public key that was contained in the certificate can only be decrypted by party B.

### Authenticating Sender Identity

The party that sends to party A the digital certificate of party B may simply be pretending to be party B. If A believes that the party is party B, and encrypts all messages to the party using party B's public key, then the party should not be able to decrypt the messages unless the party actually is party B. An imposter would receive the messages, but be unable to decrypt them.

However, it is often not enough for party A to know that the messages that it intends for party B can only be decrypted by party B. It is often just as important that party A know that the messages that it believes to be from party B are actually from party B. One technique for verifying the identity of the sender of a message involves the use of digital signatures. A digital signature is a code that can be attached to an electronically transmitted message to guarantee that the entity sending the message is really who it claims to be. Most digital signature mechanisms use a private key to encrypt a hash value generated from a message to create the digital signature for the message. A public key is used to decrypt the digital signature to recover the hash value. The hash value thus recovered can be compared to another hash value generated from the message by the recipient to verify the digital signature.

Based on the foregoing, each party to a secure communication may have two sets of keys. The first set of keys, used for encrypting/decrypting the messages, would include a public encryption key and a private decryption key. The public encryption key would be used by senders to encrypt messages to be sent to the recipients. The private decryption key would be used by the recipients to decrypt those messages. The second set of keys, used for creating and decrypting the digital signatures, would include a private encryption key and a public decryption key. The private encryption key would be used by the sender to create digital signatures to be used with outgoing messages. The public decryption key would be used by recipients of those messages to verify the identity of the sender.

Using the techniques described above, each sender retains one public message encryption key for each potential recipient, and each recipient retains one public signature decryption key for each potential sender. Unfortunately, this practice can be very burdensome in environments in which there are hundreds or thousands of partners, where each partner can be both a sender and a recipient. Each partner thus, as a sender, must retain hundreds or thousands of public message encryption keys associated with the other partners, each of whom can potentially be a recipient. Similarly, each partner, as a recipient, must retain hundreds or thousands of public signature decryption keys associated with the other partners, each of whom can potentially be a sender. This burden is amplified should any of the encryption/decryption keys become compromised. For example, if the private signature creation key of any sender becomes compromised, then each recipient must retrieve a new public signature decryption key to replace the obsolete public signature decryption key that corresponds to the compromised private signature creation key. Analogously, if the private message decryption key of any recipient becomes compromised, then each sender must retrieve a new public message encryption key to replace the obsolete public message encryption key that corresponds to the compromised message private encryption key.

### SUMMARY OF THE INVENTION

Techniques are provided for a trusted intermediary partner in a trading community to manage the encryption/decryption keys that are used in message communications between other partners of the same trading community. Each partner including the trusted intermediary partner can potentially be a sender sending a message to a recipient, or be a recipient receiving a message from a sender. In accordance with one embodiment of the invention, a recipient partner, receiving a message from a sender partner via the trusted intermediary partner, knows that the message indeed originates from an authentic sender. When appropriate, e.g., to hide the content of the message, the sender encrypts the message.

Generally, each partner, as a sender, has a private signature creation key associated with a public signature decryption key. The sender uses the private signature creation key to create a digital signature for the message while the recipient uses the public signature decryption key to authenticate the sender relative to the message. In one embodiment, each recipient keeps the public signature decryption key of the trusted intermediary, but does not have to keep the public signature decryption keys of every potential sender. The trusted intermediary keeps these public signature decryption keys. Consequently, the trusted intermediary centralizes the management of all public signature decryption keys of all potential senders, eliminating the need for each recipient to individually manage these public signature decryption keys.

In one embodiment, the sender sends a message, and includes with the message a digital signature created using the private signature creation key of the sender, to the trusted intermediary. The trusted intermediary, having the public signature decryption key associated with the private signature creation key of the sender, uses this public signature decryption key to authenticate the sender. As mentioned above, this authentication may involve (1) decrypting the digital signature using the public signature decryption key to produce a first hash value, (2) performing a hash operation on the message to produce a second hash value, and (3) comparing the first hash value to the second hash value. If the hash values match, then the message originates from the authentic sender.

Upon verifying that the message originates from an authentic sender, the trusted intermediary sends the message along with a digital signature, created from the private signature creation key of the trusted intermediary, to the recipient that is specified by the sender. The recipient, receiving the message and the digital signature and having the public signature decryption key associated with the private encryption key of the trusted intermediary, uses this public signature decryption key to authenticate the trusted intermediary, thereby verifying that the message comes from the trusted intermediary. If the message indeed comes from the authentic trusted intermediary, then the recipient knows that the message originates from an authentic sender, who has been authenticated by the trusted intermediary.

During the above communications between the sender, the trusted intermediary, and the recipient partners, where applicable, e.g., to hide the content of the message, the partners use message encryption/decryption keys to encrypt/decrypt the message. The sender uses the public message encryption key of the trusted intermediary to encrypt the message and sends the encrypted message to the trusted intermediary. The trusted intermediary, upon receiving the encrypted message, uses the private message decryption key of the trusted intermediary to decrypt the encrypted message. Upon sending the message to the recipient, the trusted intermediary uses the public encryption key of the recipient to encrypt the message. The recipient, upon receiving the encrypted message, uses the recipient's private message decryption key to decrypt the encrypted message.

In one embodiment, each potential sender keeps the public message encryption key of the trusted intermediary, but does not have to keep the public message encryption key of every potential recipient. The trusted intermediary keeps these public message encryption keys. Consequently, the trusted intermediary centralizes the management of all public message encryption keys of all potential recipients, eliminating the need for each potential sender to individually manage these public message encryption keys.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a trading community in accordance with one embodiment of the invention;

FIG. 2A shows respective digital signature creation/decryption keys that are managed by each member of the trading community of FIG. 1;

FIG. 2B shows respective message encryption/decryption keys that are managed by each member of the trading community of FIG. 1;

FIG. 3 is a flowchart illustrating the method steps in one embodiment;

FIG. 4 shows a computer network illustrating a computerized embodiment; and

FIG. 5 is a block diagram of a computer system on which embodiments of the invention may be implemented.

### DETAILED DESCRIPTION OF THE PREFERRED EMBODIMENT

Mechanisms are provided for a trusted intermediary partner to manage the encryption/decryption keys of trading partners in a trading community. In accordance with one embodiment, because the trusted intermediary maintains public signature decryption keys of all possible sender partners, a recipient partner does not have to maintain these public signature decryption keys. Similarly, because the trusted intermediary maintains public message encryption keys of all potential recipient partners, a sender partner does not have to maintain these public message encryption keys. Further, via the trusted intermediary, a recipient partner receiving a message from a sender partner knows that the message originates from an authentic sender, and not from an imposter.

### The Trading Community

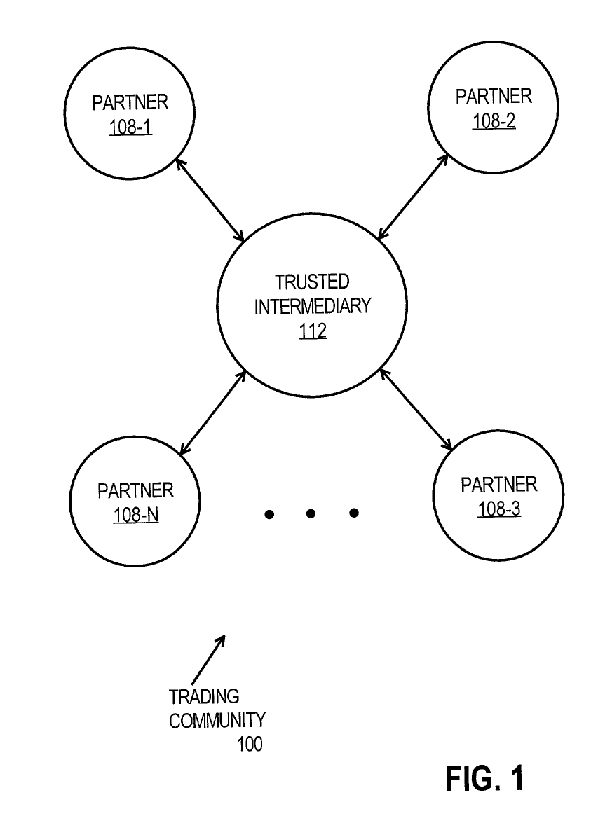

FIG. 1 shows an exemplary trading community 100 in accordance with one embodiment of the invention. Trading community 100 includes a plurality of partners 108-1 to 108-N and a trusted intermediary partner 112. Each partner 108, being a member of trading community 100, may be, for example, a customer, a supplier, a distributor, an OEM, etc., who generally exchanges confidential and secure information. For example, a customer ordering goods from a supplier must provide credit card information to the supplier while the supplier, who is to deliver the goods to the customer, must know whether the ordering customer is an authentic customer. The customer's credit information is confidential and must be kept secure from unintended personnel who can use this information for their own benefits. Therefore, this information is usually encrypted using message encryption key. Because the supplier must know that the customer is not an imposter, the customer usually sends a digital signature generated from the message together with the message to the supplier for the supplier to verify that the customer is an authentic customer. To better explain the invention, the term “message M” is used herein to refer to all information exchanged between partners 108 and 112.

### Using a Trusted Intermediary to Manage the Public Signature Decryption Keys of All Potential Sender Partners

In one embodiment, trusted intermediary 112 is a reliable third party via which a sender partner 108S sends message M to a recipient partner 108R. Trusted intermediary 112 receives message M from a sender partner 108S, verifies that sender partner 108S is not an imposter, then sends message M to the recipient partner 108R specified by sender partner 108S. Recipient partner 108R has to verify only that trusted intermediary 112 is not an imposter. Because a recipient partner 108R receives any message M directly from only trusted intermediary 112, recipient partner 108R needs to manage only the public signature decryption key of trusted intermediary 112 so that recipient partner 108R can verify that message M comes from an authentic trusted intermediary 112, and therefore originated from an authentic sender partner 108S. Recipient partner 108R does not need to manage the public decryption keys of all potential sender partners 108S. Consequently, a centralized-key-management system is created, eliminating the need for each partner 108 to manage any public signature decryption keys other than the trusted intermediary's public signature decryption key.

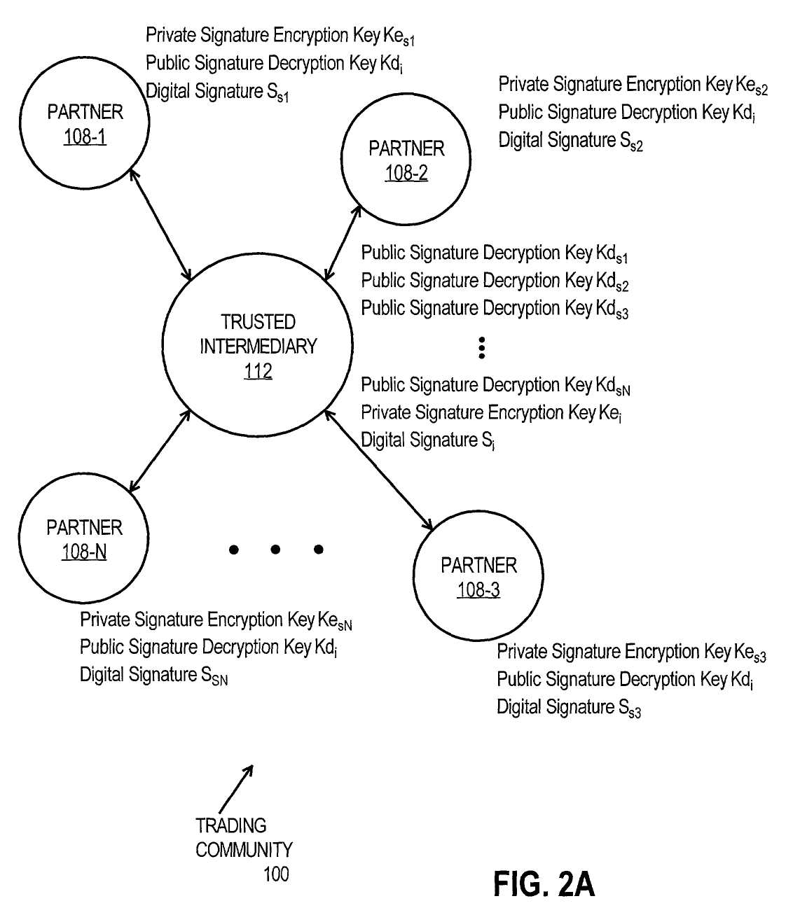

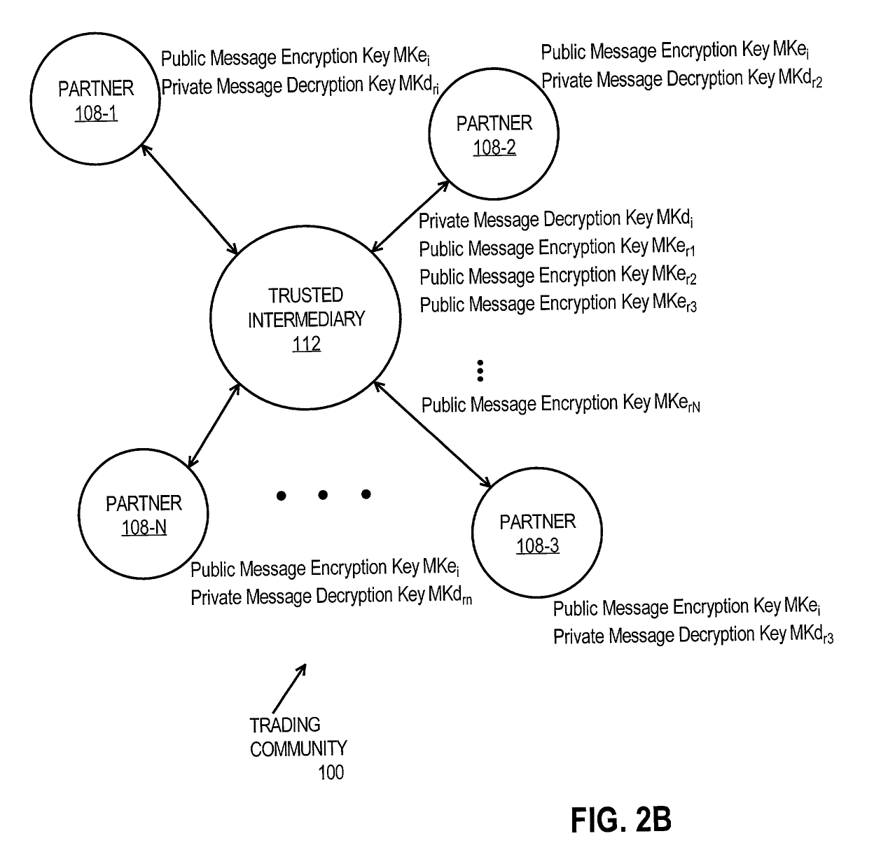

FIG. 2A shows private signature creation keys and public signature decryption keys that are managed by exemplary partners 108-1 to 108-N and trusted intermediary 112, in accordance with one embodiment of the invention. Partners 108-1 to 108-N each can be a sender of a message M, and, therefore, each manages a respective private signature creation key (Keₛ₁ to Ke_{sN}). The private signature creation key (Keₛ₁ to Ke_{sN}) is used to encrypt a hash value generated from the message M to create a respective digital signature (Sₛ₁ to S_{sN}) 0A partner 108 uses this private signature creation key Ke to create the digital signature associated with message M and sends this digital signature with the message M to trusted intermediary 112. In one embodiment, each of the digital signatures (Sₛ₁ to S_{sN}) is created by: 1) performing a one-way hash function on the message M to be transmitted with the digital signature, and 2) using the private signature creation key (Keₛ₁ to Ke_{sN}) to encrypt the result of the hash function in step 1.

A one-way hash function is a function in which a parameter X is easily hashed to produce a value Y. However, it is impossible or at least very difficult given the current technology to “dehash” the value X from the value Y.

Each of the partners 108-1 to 108-N can also be a recipient of a message M from a sender partner 108 via trusted intermediary 112, and therefore, each partner 108-1 to 108-N manages a public signature decryption key Kdᵢ that is used to decrypt the digital signature of trusted intermediary 112 in order to verify that trusted intermediary 112 is an authentic trusted intermediary. Trusted intermediary 112 can receive a message M from any partner 108-1 to 108-N, and therefore trusted intermediary 112 manages public signature decryption keys Kdₛ₁ to Kd_{sN} each corresponding to a respective partner 108-1 to 108-N. Each of the public signature decryption keys (e.g, Kdₛ₁ to Kd_{sN}, Kdᵢ) is used to verify the digital signature of the corresponding sender partner (e.g.,108-1 to 108-N, 112).

In one embodiment, verifying a digital signature is performed by 1) using the public signature decryption key to decrypt the digital signature; and 2) performing the same one-way hash function on the message M that was sent with the digital signature. If the result of the decryption in step 1) matches the result of the one-way hash function in step 2), then the digital signature verification is successful. In the above two-step verification, if the public signature decryption key of a recipient successfully decrypts the digital signature, then the recipient can be assured that the sender was the actual sender of the message M. Further, if the decrypted value of the digital signature matches the result of the one-way hash function of the message M that was transmitted with the digital signature, then the recipient party has verified that the digital signature was created from the transmitted message M.

Trusted intermediary 112, upon receiving a message M and verifying that this message M indeed comes from an authentic sender partner 108S, sends this message M to a recipient partner 108R specified by the sending partner 108S. Therefore, trusted intermediary 112 manages a signature Sᵢ and a private signature creation key Kei, which is used to create digital signature Sᵢ to be sent with the message M to the recipient partner 108R.

This embodiment of the invention is advantageous over the prior art because if a private signature creation key, e.g. Keₛ₁, of sender partner 108-1 is compromised, then only trusted intermediary 112 is required to replace the public signature decryption key Kdₛ₁ that corresponds to the private signature creation key Keₛ₁. In the prior art, each recipient partner 108-2 to 108-N would have to replace the public signature decryption key Kdₛ₁.

### Messages Received from the Trusted Intermediary have been Authenticated

Each time trusted intermediary 112 receives a message M from a sender partner 108S, trusted intermediary 112 verifies that message M indeed originates from an authentic partner 108S before sending this message M to the designated recipient partner 108R. Therefore, recipient partner 108R, receiving message M from trusted intermediary 112, knows that this message M has originated from an authentic sender partner 108S, as long as recipient partner 108R can authenticate trusted intermediary 112 from whom recipient partner 108R directly receives message M. Trusted Intermediary also Manages the Public Message Encryption Keys of all Potential Recipient Partners

In accordance with one embodiment, partners 108 and 112, when applicable, e.g., to hide the content of message M, use message encryption/decryption keys. Each partner, as a sender, uses a public message encryption key MKe of the recipient to encrypt message M. The recipient, upon receiving the encrypted message M, uses a recipient's private message decryption key MKd associated with the public message encryption MKe to decrypt the encrypted message M.

In one embodiment, because a sender partner 108S sends any encrypted message M directly to only trusted intermediary 112, sender partner 108S needs to manage the public message encryption key of trusted intermediary 112 so that sender partner 108S can encrypt message M. Sender partner 108S does not need to manage the public message encryption keys of all potential recipient partners 108R. Trusted intermediary 112, upon forwarding message M to a recipient partner 108R, uses the public message encryption key of that recipient partner 108R to encrypt message M. Therefore, trusted intermediary 112 manages public message encryption keys of all potential recipient partners. Consequently, a centralized-key-management system is created, eliminating the need for each partner 108 to manage any public message encryption keys other than the trusted intermediary's public message encryption key and the partner's private message decryption key.

FIG. 2B shows public message encryption keys and private message decryption keys that are managed by partners 108 and 112, in accordance with one embodiment of the invention. Partners 108-1 to 108-N each can be a recipient of a message M, and, therefore, each manages a respective private message decryption key (MKdᵣ₁ to MKd_{rN}). As discussed above, a partner 108 uses this private message decryption key MKd to decrypt the encrypted message M that was sent from trusted intermediary 112. Each of the partners 108-1 to 108-N can also be a sender of a message M to a recipient partner 108R via trusted intermediary 112, and therefore, each partner 108-1 to 108-N manages a public message encryption key MKeᵢ that is used to encrypt message M. Trusted intermediary 112 can receive a message M from any partner 108-1 to 108-N, and therefore trusted intermediary 112 manages its own private message decryption key MKdᵢ to decrypt the encrypted message M. Further, trusted intermediary 112, upon forwarding message M to a recipient partner 108R specified by the sending partner 108S, uses public message encryption key MKe of the recipient partner 108R to encrypt message M. Therefore, trusted intermediary 112 manages public message encryption keys MKeᵣ₁ to MKE_{rN}, each of which corresponds to a respective recipient partner 108-1 to 108N.

This embodiment of the invention is advantageous over the prior art because if a private message decryption key, e.g. MKdᵣ₁, of recipient partner 108-1 is compromised, then only trusted intermediary 112 is required to replace the public message encryption key MKeᵣ₁ that corresponds to the private message decryption key MKdᵣ₁. In the prior art, each sender partner 108-2 to 108-N would have to replace the public message encryption key MKeᵣ₁.

### Method Steps in Accordance with an Embodiment

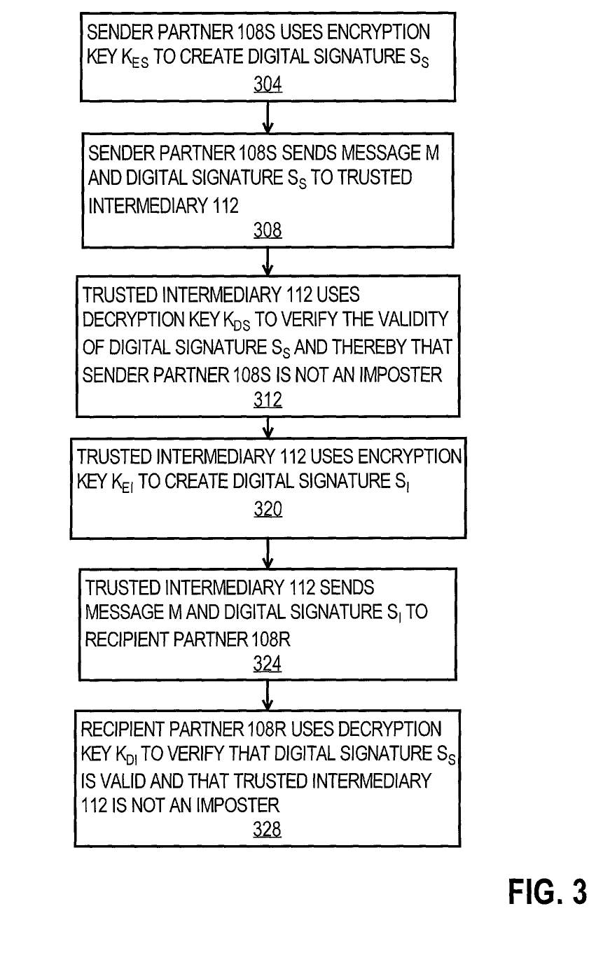

FIG. 3 shows a flowchart 300 illustrating the method steps in which a sender partner 108S sends a message M via trusted intermediary 112 to a recipient partner 108R.

In step 304, sender partner 108S uses private signature creation key Keₛ to create digital signature Sₛ.

In step 308, sender partner 108S sends message M and digital signature Sₛ to trusted intermediary 112. Sender partner 108S also informs trusted intermediary 112 of a recipient partner 108R to whom trusted intermediary 112 sends message M.

In step 312, upon receiving message M and digital signature Ss from sender partner 108 S, trusted intermediary 112 uses public signature decryption key Kdᵢ to verify the validity of digital signature Ss. If digital signature Ss is valid, then trusted intermediary 112 knows that message M comes from an authentic sender partner 108S, and not from an imposter.

In step 320, upon verifying that sender partner 108S is not an imposter, trusted intermediary 112 uses private signature creation key Kei to create digital signature Sᵢ.

In step 324, trusted intermediary 112 sends the message M received from sender partner 108S and digital signature Sᵢ to the recipient partner 108R specified by sender partner 108S. Those skilled in the art will recognize that the digital signature (e.g., Ss, Sᵢ) may be part of message M or attached to message M. The specific relationship between the signature and the message may vary from implementation to implementation and the present invention is not limited to any particular implementation.

In step 328, upon receiving message M and digital signature Sᵢ, recipient partner 108R uses public signature decryption key Kdᵢ to verify that digital signature Sᵢ is valid and therefore that trusted intermediary 112 is not an imposter. If trusted intermediary 112 is not an imposter, then recipient partner 108R knows that message M indeed originates from an authentic sender partner 108S, who has been authenticated by trusted intermediary 112.

In the above illustrative flowchart, each partner 108 and 112 may encrypt message M and the corresponding recipient party decrypts message M accordingly. For example, in step 308, before sending message M to trusted intermediary 112, sender partner 108S uses public message encryption key MKeᵢ to encrypt message M. Trusted intermediary 112 in step 312 uses private message decryption key MKdᵢ to decrypt the encrypted message M. Similarly, trusted intermediary in step 324, before sending message M to recipient partner 108R uses public message encryption key MKeᵣ to encrypt message M. Accordingly, recipient partner 108R in step 328 uses private message decryption key MKdᵣ to decrypt the encrypted message M. Computer Implementation of an Embodiment

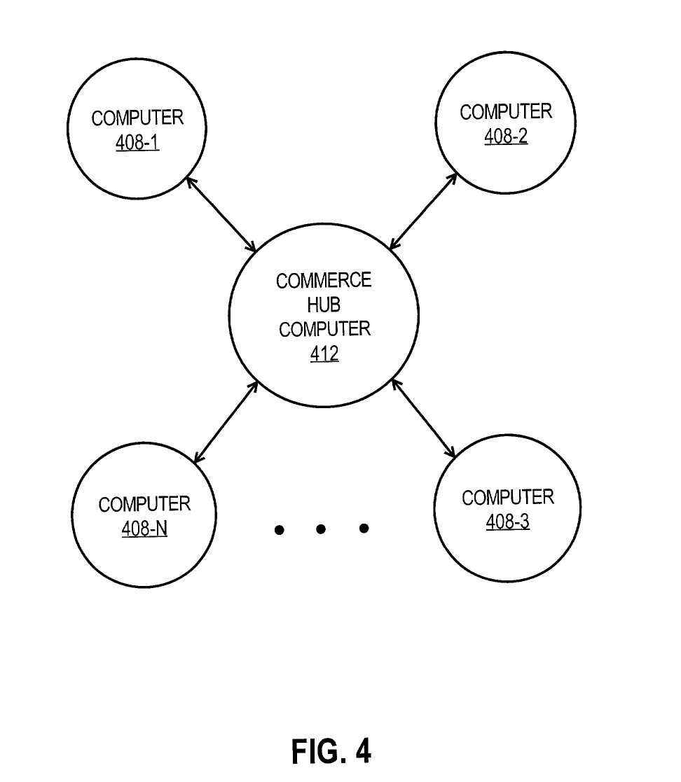

FIG. 4 shows a computer network 400 illustrating a computerized embodiment of the invention. Network 400 includes a plurality of computers 408-1 to 408-N and a “Commerce Hub” computer 412. Each computer 408-1 to 408-N corresponds to a partner 108-1 to 108-N (of FIG. 2) and their respective digital signature Sₛ₁ to S_{sN}, private signature creation keys Keₛ₁ to Ke_{sN}, and public signature decryption key Kdᵢ. For example, computers 108-1 to 408-N each creates a respective signature Sₛ₁ to S_{sN}, a respective private signature creation key Keₛ₁ to Ke_{sN}, and public signature decryption key Kdᵢ. Commerce Hub computer 412 corresponds to trusted intermediary 112, e.g., Commerce Hub computer 412 creates signatures Sᵢ, private signature creation key Kei, and public signature decryption keys Kdₛ₁ to Kd_{sN}.

When message encryption/decryption keys are used, each computer 408-1 to 408-N stores a public message encryption key MKeᵢ and a respective private message decryption key MKdᵣ₁ to MKd_{rN}. Commerce Hub computer 412 stores private message decryption key MKdᵢ and public message encryption keys MKeᵣ₁ to MKe_{rN}.

In one embodiment, computers 408 and 412, as in appropriate steps in the method of FIG. 3, are configured to automatically create digital signatures (e.g., Sₛ, Sᵢ) of each partner 108 and 112, and automatically verifies these signatures. Computers 408 and 412 also automatically encrypt/decrypt message M and transmit message M with the appropriate digital signatures Sₛ and Sᵢ.

Further, in the above discussion, a pair of private signature creation key and public signature decryption key or a pair of public message encryption key and private message decryption key are used for illustrative purposes only. Any pair of keys for creating and verifying a digital signature or encrypting and decrypting a message is effective. The invention is thus not limited to the above illustrative embodiments. Additionally, a private key is known only to the owner (or authorized personnel) of the key and kept secret from unauthorized personnel, and a public key is known to the public.

### Hardware Overview

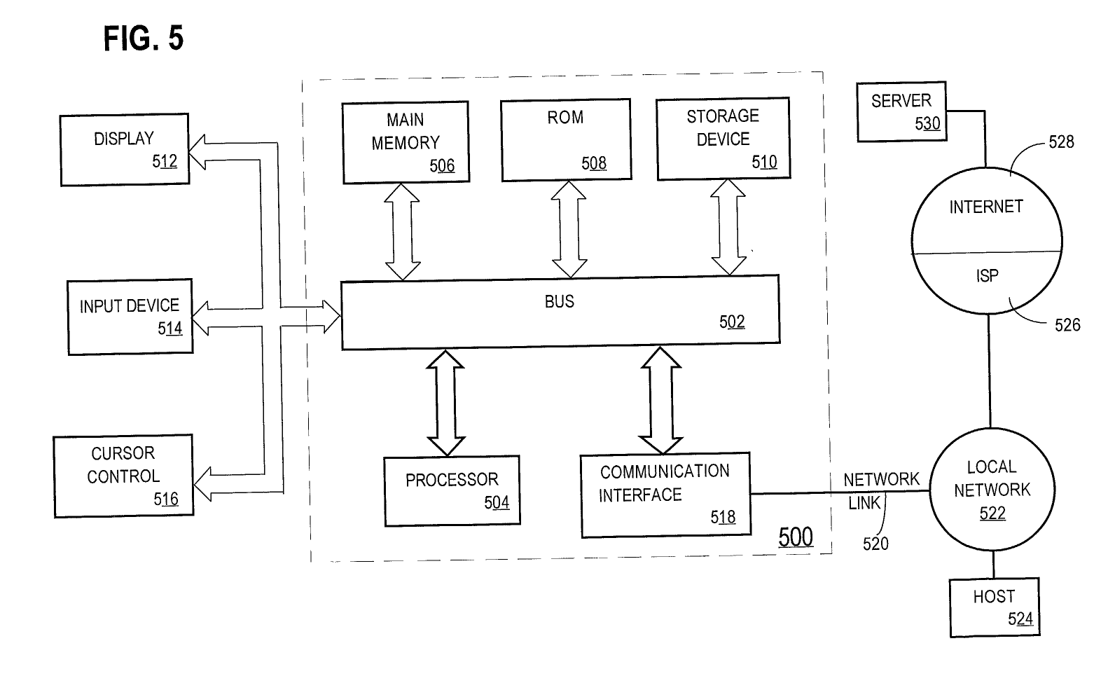

FIG. 5 is a block diagram that illustrates a computer system 500 upon which an embodiment of the invention may be implemented. In particular, computer system 500 may implement a computer 408 or a Commerce Hub computer 412 configured to operate as described above. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are implemented by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. In accordance with the invention, one such downloaded application implements the techniques described herein.

The received code may be executed by processor 504 as it is received, and/or stored in storage device 510, or other non-volatile storage for later execution. In this manner, computer system 500 may obtain application code in the form of a carrier wave.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for authenticating messages communicated between partners that belong to a plurality of partners, the method comprising the steps of:
maintaining at a trusted intermediary a signature decryption key for each partner of said plurality of partners that is authorized to use said trusted intermediary to send messages;
receiving at said trusted intermediary messages originated by partners of said plurality of partners that are intended for other partners of said plurality of partners;
for each message thus received, the trusted intermediary performing the steps of
using the signature decryption key associated with the partner that sent the message to determine whether the message was actually sent by that partner; and
if the message was actually sent by that partner, then sending the message to the partner for which the message is intended along with a digital signature of said trusted intermediary to indicate that the trusted intermediary has verified that the message was actually sent by the partner that sent the message.

2. The method of claim 1 wherein the signature decryption key for each partner of said plurality of partners is a public signature decryption key associated with a private signature creation key.

3. The method of claim 1 wherein the signature decryption key for each partner of said plurality of partner is used to decrypt a digital signature associated with a message that is sent along with the digital signature.

4. The method of claim 1 wherein the digital signature of the trusted intermediary is associated with a message that is sent along the digital signature of the trusted intermediary.

5. The method of claim 1 wherein the digital signature of the trusted intermediary is encrypted by a private signature creation key associated with a public signature decryption key.

6. A computer-readable medium storing computer code for causing a computer to perform a method for authenticating messages communicated between partners that belong to a plurality of partners, by the steps of:
maintaining at a trusted intermediary a signature decryption key for each partner of said plurality of partners;
receiving at said trusted intermediary messages originated by partners of said plurality of partners that are intended for other partners of said plurality of partners;
for each message thus received, the trusted intermediary performing the steps of
using the signature decryption key associated with the partner that sent the message to determine whether the message was actually sent by that partner; and
if the message was actually sent by that partner, then sending the message to the partner for which the message is intended along with a digital signature of said trusted intermediary to indicate that the trusted intermediary has verified that the message was sent actually sent by the partner that sent the message.

7. The computer-readable medium of claim 6 wherein the signature decryption key for each partner is a public signature decryption key associated with a private signature creation key.

8. The computer-readable medium of claim 6 wherein the signature decryption key for each partner is used to decrypt a digital signature associated with a message is that sent along with the digital signature.

9. The computer-readable medium of claim 6 wherein the digital signature of the trusted intermediary is associated with a message that is sent along with the digital signature.

10. The computer-readable medium of claim 6 wherein the digital signature of the trusted intermediary is encrypted by a private signature creation key associated with a public signature decryption key.

11. A computer for use in communications between partners that belong to a plurality of partners, comprising:
storage means configured to store a signature decryption key for each partner of said plurality of partners that is authorized to use said computer to send messages;
receiving means configured to receive messages that are originated by partners of said plurality of partners and that are intended for other partners of said plurality of partners;
signature decryption means; and
sending means; wherein
for each message thus received,
said signature decryption means is configured to use the signature decryption key associated with the partner that sent the message to determine whether the message was actually sent by that partner; and
if the message was actually sent by that partner, said sending means is configured to send the message along with a digital signature of said trusted intermediary to the partner for which the message is intended; wherein said digital signature of said trusted intermediary is used to indicate that said trusted intermediary has verified that the message was actually sent by the partner that sent the message.

12. The computer of claim 11 further comprising signature encryption means by which said digital signature of said trusted intermediary was created.

13. A computer network for use in communications between partners that belong to a plurality of partners, comprising:
a plurality of computers each of which is configured to store a respective signature creation key of a partner of said plurality of partners that is authorized to use a trusted intermediary computer to send messages;
wherein said trusted intermediary computer is configured
to store a plurality of signature decryption keys each of which corresponds to the respective signature creation key that is stored in each of said plurality of computers;
wherein, upon receiving messages that are originated by partners of said plurality of partners and that are intended for other partners of said plurality of partners, said trusted intermediary computer, for each message thus received, is configured
to use the signature decryption key associated with the partner that sent the message to determine whether the message was actually sent by that partner; and
if the message was actually sent by that partner, then sending the message to the partner for which the message is intended along with a digital signature of said trusted intermediary to indicate that the trusted intermediary has verified that the message was actually sent by that partner that sent the message.

14. A method for a trusted intermediary to manage keys used in communications between partners that belong to a plurality of partners, the method comprising the steps of:
a trusted intermediary maintaining a message encryption key for each partner of said plurality of partners that is authorized to use said trusted intermediary to receive messages; wherein
upon receiving messages that are originated by partners of said plurality of partners and that are intended for other partners of said plurality of partners, said trusted intermediary, for each message thus received, performing the steps of
encrypting the message using the message encryption key associated with the partner for which the message is intended; and
sending the encrypted message to the partner for which the message is intended.

15. The method of claim 14 wherein the message encryption key for each partner of said plurality of partners is a public message encryption key associated with a private message decryption key.

16. The method of claim 14 wherein each of the messages that are originated by partners of said plurality of partners and that are intended for other partners of said plurality of partners was encrypted using a message encryption key associated with the trusted intermediary.

17. The method of claim 16 wherein said message encryption key associated with said trusted intermediary is a public message encryption key that is associated with a private message decryption key.

18. A computer-readable medium storing computer code for causing a computer to perform a method for a trusted intermediary to manage keys used in communications between partners that belong to a plurality of partners, by the steps of:
said trusted intermediary maintaining a message encryption key for each partner of said plurality of partners that is authorized to use said trusted intermediary to receive messages; wherein
upon receiving messages originated by partners of said plurality of partners that are intended for other partners of said plurality of partners, said trusted intermediary, for each message thus received, performing the steps of
encrypting the message using the message encryption key associated with the partner for which the message is intended; and
sending the encrypted message to the partner for which the message is intended.

19. The computer-readable medium of claim 18 wherein the message encryption key for each partner of said plurality of partners is a public message encryption key associated with a private message decryption key.

20. The computer-readable medium of claim 18 wherein the computer further performs the step of:
each partner of said plurality of partners that sends messages to said trusted intermediary maintains a message encryption key associated with a message decryption key of said trusted intermediary.

21. The computer-readable medium of claim 20 wherein said message encryption key associated with said message decryption key of said trusted intermediary is a public message encryption key and said message decryption key of said trusted intermediary is a private message decryption key.

22. A computer for use in communications between partners that belong to a plurality of partners, comprising:
storage means configured to store a message encryption key for each partner of said plurality of partners that is authorized to use said computer to receive messages;
message encryption means;
sending means; and
receiving means configured to receive messages that are originated by partners of said plurality of partners and that are intended for other partners of said plurality of partners; wherein
for each message thus received,
said message encryption means encrypts the message using the message encryption key associated with the partner for which the message is intended; and
said sending means sends the encrypted message to the partner for which the message is intended.

23. The computer system of claim 22 further comprising message decryption means that, for each message thus received, produces that message from an encrypted message.

24. A computer network for use in communications between partners that belong to a plurality of partners, comprising:
a plurality of computers each of which is configured to store a respective message decryption key of a partner of said plurality of partners that is authorized to use a trusted intermediary computer to receive messages;
wherein said trusted intermediary computer is configured
to store a plurality of message encryption keys each of which corresponds to the respective message decryption key that is stored in each of said plurality of computers;
wherein, upon receiving messages that are originated by partners of said plurality of partners and that are intended for others partners of said plurality of partners, said trusted intermediary computer, for each message thus received, is configured
to encrypt the message using the message encryption key associated with the partner for which the message is intended, and
to send the encrypted message to the partner for which the message is intended.
